(19) United States
(12) Patent Application Publication
(10) Pub. No.: US 2026/0005263 A1
(43) Pub. Date: Jan. 1, 2026

(54) Polar Plate for Fuel Cell, Preparation Method, Fuel Cell System, and Vehicle

(71) Applicant: Robert Bosch GmbH, Stuttgart (DE)

(72) Inventors: Xinlong Xu, Shanghai (CN); Jingjun Zhang, Shanghai (CN)

(21) Appl. No.: 19/253,754

(22) Filed: Jun. 28, 2025

(30) Foreign Application Priority Data
Jul. 1, 2024 (CN) 2024 1087 9286.9

(51) Int. Cl. H01M 8/0228; H01M 8/0247; H01M 8/10

(52) U.S. Cl. CPC H01M 8/0228; H01M 8/0247; H01M 2008/1095; H01M 2250/20

(57) ABSTRACT

A polar plate for a fuel cell, a preparation method, a fuel cell system, and a vehicle are disclosed. The polar plate for the fuel cell includes (i) a substrate used for allocating a target reactant of the fuel cell and having an electrical conductivity, (ii) a first material layer arranged on an upper surface of the substrate and having a first surface used for being in contact with an upper surface of the substrate, and (iii) a second material layer comprising a catalytic material layer used for resisting an inverted voltage of the fuel cell and arranged on a second surface of the first material layer opposite to the first surface, the second material layer having a contact surface used for being in contact with a gas diffusion layer of the fuel cell. In solutions provided herein, the objective of resisting the inverted voltage of the fuel cell is achieved by arranging a second material layer for resisting an inversion on the polar plate of the fuel cell, thereby improving the corrosion resistance performance of the polar plate at a high potential, ensuring the working stability of the fuel cell, and improving the durability of the fuel cell.

This application claims priority under 35 U.S.C. § 119 to application no. CN 2024 1087 9286.9, filed on Jul. 1, 2024 in China, the disclosure of which is incorporated herein by reference in its entirety.

The present disclosure relates to the field of fuel cell technologies, and more particularly relates to a polar plate for a fuel cell, a preparation method, a fuel cell system, and a vehicle.

### BACKGROUND

A fuel cell system is an electrochemical power storage device that generates electrical energy through an electrochemical reaction of anodic hydrogen and cathodic oxygen-containing gas, which has the advantage of a high energy conversion rate and no pollution emission, is a new generation of green energy, and already has important applications in many fields. For example, in the field of new energy vehicles, a proton exchange membrane fuel cell with hydrogen as fuel has become a class of widely used vehicle power cells.

In practical applications, gas supply of a fuel cell may be insufficient due to uneven gas distribution, gas shortage, etc. within a fuel cell stack. When the gas supply of the fuel cell is insufficient, the anodic potential changes, resulting in a voltage inversion of the fuel cell. At this point, structural elements of the fuel cell, such as bipolar plate assemblies, membrane electrode assemblies, etc., can cause some irreversible damage that affects not only the durability of the fuel cell, but even the risk of short circuits, explosion, etc. of the fuel cell when severe.

### SUMMARY

Embodiments of the present disclosure provide a polar plate for a fuel cell, a preparation method, a fuel cell system, and a vehicle. In embodiments of the present disclosure, the objective of resisting an inverted voltage of the fuel cell is achieved by arranging a second material layer on a substrate of the fuel cell, thereby improving the corrosion resistance performance of a metal polar plate at a high potential, ensuring the working stability of the fuel cell and improving the durability of the fuel cell.

In a first aspect of the present disclosure, there is provided a polar plate for a fuel cell, comprising a substrate configured to be used for allocating a target reactant of the fuel cell and having an electrical conductivity; and a first material layer arranged on an upper surface of the substrate and having a first surface used for being in contact with the upper surface of the substrate; and a second material layer comprising a catalytic material layer for resisting an inverted voltage of the fuel cell, the catalytic material layer comprising a catalytic material and being arranged on a second surface of the first material layer opposite to the first surface, and the second material layer having a contact surface used for being in contact with a gas diffusion layer of the fuel cell.

In a second aspect of the present disclosure, there is provided a preparation method of a polar plate for a fuel cell, comprising: providing a substrate, the substrate being configured to allocate a target reactant of the fuel cell and having an electrical conductivity; and providing a first material layer, the first material layer being arranged on an upper surface of the substrate and having a first surface used for being in contact with the upper surface of the substrate; and providing a second material layer, the second material layer comprising a catalytic material layer for resisting an inverted voltage of the fuel cell, the catalytic material layer comprising a catalytic material and being arranged on a second surface of the first material layer opposite to the first surface, and the second material layer having a contact surface used for being in contact with a gas diffusion layer of the fuel cell.

In a third aspect of the present disclosure, there is provided a fuel cell system, comprising the polar plate for the fuel cell according to the first aspect, wherein the polar plate is arranged on at least one side in an anodic side and a cathodic side of the fuel cell system.

In a fourth aspect of the present disclosure, there is provided a vehicle, comprising a fuel cell system according to any one of the third aspect.

It will be understood that the content described in the Summary is not intended to limit key or important features of the embodiments of the present disclosure, nor is it intended to limit the scope of the present disclosure. Other features of the present disclosure will become readily understood by the following description.

### BRIEF DESCRIPTION OF THE DRAWINGS

Above and other features, advantages and aspects of various embodiments of the present disclosure will become more apparent in combination with the accompanying drawings and with reference to the following detailed description. In the accompanying drawings, like or similar accompanying drawing annotations designate like or similar elements, wherein:

FIG. 1 shows a schematic diagram of a fuel cell system in which a plurality of embodiments of the present disclosure may be implemented;

FIG. 2A shows a schematic view of a polar plate for a fuel cell according to some embodiments of the present disclosure;

FIG. 2B shows a top schematic view of a protective structure of a polar plate for a fuel cell according to some embodiments of the present disclosure;

FIG. 2C shows a cross-sectional schematic view of the protective structure obtained after sectioning the protective structure in FIG. 2B along the arrow direction according to some embodiments of the present disclosure;

FIG. 2D shows a cross-sectional schematic view of the protective structure obtained after sectioning the protective structure in FIG. 2B along the arrow direction according to some other embodiments of the present disclosure;

FIG. 2E shows a cross-sectional schematic view of the protective structure obtained after sectioning the protective structure in FIG. 2B along the arrow direction according to further embodiments of the present disclosure;

FIG. 3A shows a comparison schematic view of polarization curve experimental data of a polar plate for a fuel cell according to some embodiments of the present disclosure;

FIG. 3B shows a comparison schematic view of ICR experimental data of a polar plate for a fuel cell after applying normal voltage conditions and after applying a 1.6 V voltage for 1 hour according to some embodiments of the present disclosure; and

FIG. 4 shows a flow chart of a preparation method of a polar plate for a fuel cell according to some embodiments of the present disclosure.

In general, the same reference numerals are used throughout the accompanying drawings and in the specific embodiments appended thereto to denote the same or similar components. The accompanying drawings need not be drawn to scale. The dimensions of the components or regions in the accompanying drawings may be enlarged for illustration. While the accompanying drawings show the regions with lines and boundaries, some or all of these lines and/or boundaries may be ideal. In fact, the boundaries and/or lines may be non-observable and/or irregular.

### DETAILED DESCRIPTION

The embodiments of the present disclosure will be described in further detail below with reference to the accompanying drawings. Although certain embodiments of the present disclosure are shown in the accompanying drawings, it should be understood that the present disclosure may be implemented in various forms and should not be construed as being limited to the embodiments set forth herein, rather these embodiments are provided for a more thorough and complete understanding of the present disclosure. It will be understood that the accompanying drawings and embodiments of the present disclosure are for exemplary purposes only and are not intended to limit the scope of protection of the present disclosure, and the embodiments of the present disclosure that are described below with reference to the accompanying drawings are for illustrative purposes only.

In the description of the embodiments of the present disclosure, the term “comprise” and similar terms shall be known as open-ended inclusions, i.e., “including but not limited to”. The term “based on” should be understood as “at least partially based on”. The term “one embodiment” or “the embodiment” should be understood as “at least one embodiment”. The terms “first”, “second”, etc., can refer to different or the same objects. Other explicit and implicit definitions may be included below.

The terms up, down, left, right, front, back, front face, back face, top, bottom, and the like mentioned or possibly mentioned in the Description are defined relative to the constructions shown in the accompanying drawings and are relative concepts, and therefore may vary accordingly depending on their different locations and different states of use. Therefore, these or other orientation terms should not be explained as limiting. Further, the terms “first”, “second”, “third” and the like, or similar expressions are used solely for the purpose of description and differentiation and are not to be understood as indicating or implying the relative importance of the respective member.

The inventors of the present disclosure have found that gas may be insufficient due to uneven gas distribution within the fuel cell stack, stack starting and stopping, or improper operation. When the gas supply of the fuel cell is insufficient, especially when the supply of anodic hydrogen is insufficient, the anodic potential changes, resulting in a voltage reversion of the fuel cell. At this point, structural elements inside the fuel cell, such as bipolar plates, membrane electrode assemblies, etc., suffer from a certain degree of corrosion, this damage affects not only the durability of the fuel cell, but even the risk of short circuits, explosion, etc. of the fuel cell when severe.

The embodiments of the present disclosure provide a polar plate for a fuel cell, the objective of resisting an inverted voltage of the fuel cell is achieved in the solution of the present disclosure by arranging a catalytic material layer on a substrate of the fuel cell, thereby improving the corrosion resistance performance of a metal polar plate at a high potential, ensuring the working stability of the fuel cell and improving the durability of the fuel cell.

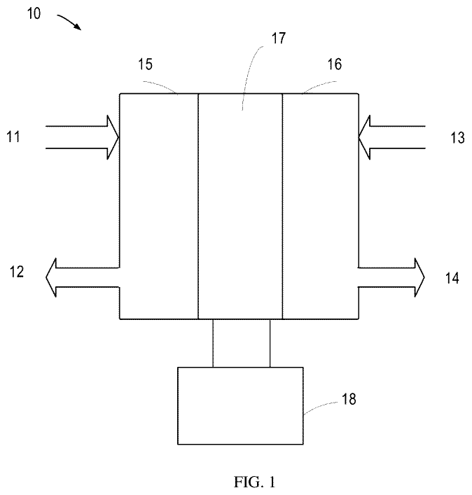

FIG. 1 shows a schematic diagram of a fuel cell system 10 in which a plurality of embodiments of the present disclosure may be implemented. Taking a simple fuel cell system structure as an example, the concepts of the embodiments of the present disclosure may be applied regardless of the fuel cell topology. As shown in FIG. 1, in the fuel cell system 10, an anodic chamber 15, a proton exchange membrane 17, and a cathodic chamber 16 are included. The proton exchange membrane 17 is positioned between the anodic chamber 15 and the cathodic chamber 16, is a semi-permeable membrane, and is used for conducting protons and isolating reactants positioned in the anodic chamber 15 and the cathodic chamber 16. The anodic chamber 15, the proton exchange membrane 17, and the cathodic chamber 16 collectively form a fuel cell. The hydrogen in the anodic chamber 15 and the oxygen-containing gas in the cathodic chamber 16 react on the proton exchange membrane 17, thereby producing a current which can be supplied to external devices such as motors, cells, etc. via a DC-DC converter 18, so as to achieve the fuel cell supplying power to the motors, charging the cells, etc. The fuel cell system 10 also comprises an anodic inlet 11 and an anodic outlet 12 coupled to an anodic loop, a cathodic inlet 13 and a cathodic outlet 14 coupled to a cathodic loop, which together form the fuel cell system with the anodic chamber 15, the membrane electrode 17, and the cathodic chamber 16. The anodic loop is used for providing hydrogen for the anodic chamber 15, and hydrogen flows from the anodic inlet 11 into the anodic chamber 15; the cathodic loop is used for providing oxygen-containing gas for the cathodic chamber 16, oxygen in the oxygen-containing gas may react at the proton exchange membrane 17, and product water generated from the reaction may be expelled through the cathodic outlet 14. It will be understood that the fuel cell system 10 shown in FIG. 1 is only an example of the embodiments of the present disclosure, not a limitation to the present disclosure.

The anodic hydrogen and the cathodic oxygen-containing gas are evenly allocated through the polar plate to a gas diffusion layer of the anodic chamber and/or the cathodic chamber. Typically, the polar plate is one of the important components of the fuel cell and plays a role in directing the flow direction of reaction gas, evenly allocating the reaction gas to the gas diffusion layer of the anodic chamber or the cathodic chamber to reach a catalyst layer, preventing the gas from passing through, draining product water, discharging heat, collecting and conducting electrons, and supporting membrane electrodes, etc. Its weight accounts for 60-80% of the total weight of the stack, and its cost accounts for about 30%-45% of the total cost of the stack. As a result, the performance of the polar plate has an important impact on the performance of the stack of the fuel cell. The metal polar plate has an excellent electrical and thermal conductivity, its use in a proton exchange membrane fuel cell (PEMFC) has the significant advantages such as low costs, ease of manufacturing, high mechanical strength and high-power density, etc., and the stack formed by assembling metal polar plates has the advantages of high-power density, good vibration resistance, fast cold start, etc. Therefore, the metal polar plate is generally regarded as the preferred choice for the polar plate of the fuel cell. However, when the gas supply of the fuel cell is insufficient, especially when the anodic hydrogen supply is insufficient, the anodic potential of the fuel cell changes, resulting in an inversion of the fuel cell. In case that the inversion occurs, an inversed voltage easily causes corrosive pitting to a metal polar plate, which seriously affects the use life of the polar plate. At the same time, the metal polar plate releases metal ions during the process of corrosion, and the released ions will contaminate catalysts and membrane electrodes, thereby further reducing the output performance of the fuel cell stack.

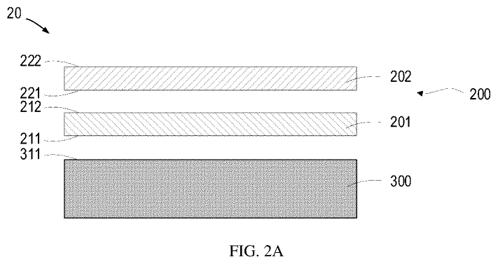

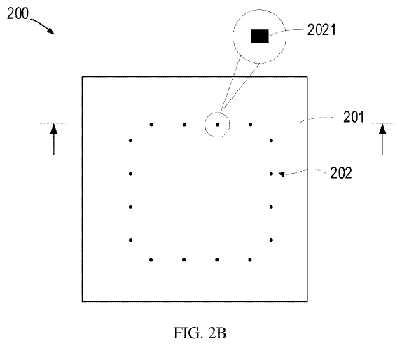

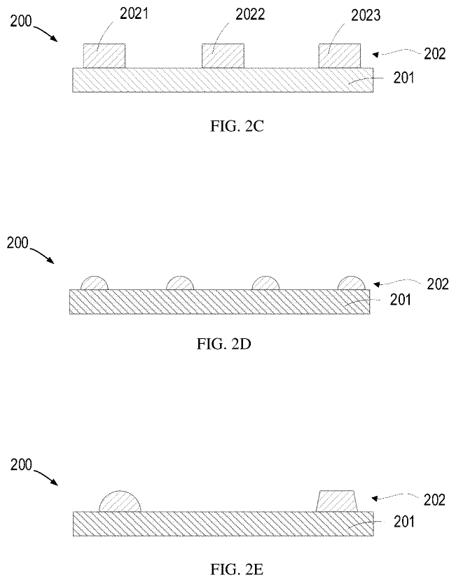

FIG. 2A is a schematic view of a polar plate 20 for a fuel cell 10 according to some embodiments of the present disclosure. In some embodiments, the polar plate 20 comprises a substrate 300, a first material layer 201, and a second material layer 202. The substrate 300 is used for allocating a target reactant of the fuel cell, and has an electrical conductivity. The target reactant comprises anodic hydrogen and cathodic oxygen-containing gas. A first material layer 201 is arranged on an upper surface 311 of the substrate 300 to be used for reducing corrosion to the substrate 300, and meanwhile, the first material layer 201 has a first surface 211 used for being in contact with the upper surface 311 of the substrate 300 and a second surface 212 in contact with the second material layer 202. In some embodiments, the substrate 300 has a flow field of a particular geometry, such as a strip shape, a serpentine shape, etc., to be used for allocating the anodic hydrogen or cathodic oxygen-containing gas; the first material layer 201 is a protective coating 201 for preventing corrosion caused by contact of the substrate 300 with a fluid medium comprising a target reactant and a product in the fuel cell 10; the second material layer 202 comprises a catalytic material layer 202, and the catalytic material layer 202 comprises a catalytic material. That is, the protective coating 201 is arranged between the substrate 300 and the catalytic material layer 202, the catalytic material layer 202 is arranged on a second surface 212 of the protective coating 201 opposite to the first surface 211 and has a contact surface 222 used for being in contact with the gas diffusion layer of the fuel cell. The gas diffusion layer is positioned in the anodic chamber 15 and the cathodic chamber 16 of the fuel cell, and interior structures of the anodic chamber 15 and the cathodic chamber 16 further comprise catalyst layers, electrodes, etc. When an inversion occurs in the fuel cell, the higher inversed voltage causes the reaction product water in the fuel cell to lose electrons and become oxygen under the effect of the catalytic material layer 202 having a catalytic action, with the reaction process as follows:

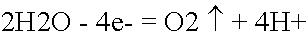

The hydrolytic reaction dilutes the higher inversed voltage, thereby reducing the release of the metal ions on the metal polar plate 20 and also reducing the ohm loss on the metal polar plate 20. In the embodiments of the present disclosure, the objective of resisting the inverted voltage of the fuel cell is achieved by arranging the catalytic material layer on the polar plate of the fuel cell, thereby achieving the effect of protecting the performance stability of the metal polar plate, further ensuring the working stability of the fuel cell, and improving the durability of the fuel cell. In one aspect, the solution of the present disclosure inhibits the formation of metal oxides on the metal polar plate, such that interfacial contact resistance (ICR) of the polar plate remains stable, and the ohm loss of the fuel cell is not increased; on the other hand, the solution of the present disclosure inhibits the release of metal ions on the metal polar plate, thereby remitting the decomposition of the proton exchange membrane, and accordingly extending the lifespan of the proton exchange membrane. The solution of the present disclosure improves the working performance of the fuel cell in a number of respects, and significantly improves the durability of the fuel cell.

In some embodiments, the first material layer 201 comprises a corrosion resistant material layer 201, the corrosion resistant material layer 201 comprises a corrosion resistant material. To ensure the electrical and thermal conductivity of the polar plate 20, both the first material layer 201 and the second material layer 202 have an electrical conductivity. The second material layer 202 comprises a catalytic material layer 202 having an electrical conductivity, thereby forming an anti-inversion structure. The anti-inversion structure is arranged between the corrosion resistant material layer 201 and the gas diffusion layer of the fuel cell. In case that the fuel cell has an inversion phenomenon, the reaction product water undergoes a hydrolytic reaction under the effect of the catalytic material layer 202 having a catalytic effect, and dilutes the higher inverted voltage, thereby reducing the release of metal ions of the substrate 300 and the corrosion resistant material layer 201 in the metal polar plate 20, inhibiting the degree of corrosion of the substrate 300 and the corrosion resistant material layer 201, and also reducing the ohm loss of the substrate 300 and the corrosion resistant material layer 201. In the embodiments of the present disclosure, the projective of resisting the inverted voltage of the fuel cell is achieved while ensuring the electrical conductivity and the corrosion resistance performance of the polar plate 20 under normal operating voltage conditions by arranging the anti-inversion structure having an electrical conductivity and comprising the catalytic material layer. In the embodiments of the present disclosure, by resisting the inverted voltage of the fuel cell, the performance stability of the substrate 300 and the corrosion resistant material layer 201 at the time of inversion is protected, thereby protecting the performance stability of the metal polar plate 20, further ensuring the working stability of the fuel cell, and improving the durability of the fuel cell.

In some embodiments, the material of the substrate 300 is selected from at least one of: stainless steel, titanium alloy, and aluminum alloy, and the substrate is configured as a gas diffusion layer for evenly allocating the hydrogen or oxygen-containing gas from the outside of the fuel cell to the anodic chamber and/or the cathodic chamber. In some embodiments, the material of the first material layer 201 is selected from at least one of: metal nitrides, metal carbides, carbons, etc., these protective coating materials are currently ideal metal polar plate coating materials that exhibit a good electrical conductivity and corrosion resistance in the normal working conditions of the proton exchange membrane fuel cell, such as 0-1.2 V. In some embodiments, the catalyst material in the second material layer 202 comprises an electrolytic water catalytic material. The electrolytic water catalytic material is selected from at least one of: ruthenium Ru, platinum Pt, iridium Ir, cobalt Co, nickel Ni, rhenium Re, antimony Sb, tantalum Ta, tin Sn, and oxides thereof. In some embodiments, when the fuel cell has an extreme situation such as a voltage inversion, with an electrical potential above 1.5 V, on one hand, the catalytic material in the second material layer 202 remains stable at a high voltage and has a high electrical conductivity to ensure the electrical conductivity between the metal polar plate 20 and the gas diffusion layer of the fuel cell; on the other hand, the catalytic material in the second material layer 202 exhibits high activity on water oxidation, and during the reversing process of a forced oxygenation reaction, the second material layer 202, which is highly active for water oxidation, preferentially undergoes electron transfer, thereby avoiding corrosion to the first material layer 201 and the substrate 300, and achieving the effect of protecting the substrate 300 and the first material layer 201. In the technical solution of the present disclosure, since the substrate 300 and the first material layer 201 are protected, on one hand, the formation of metal oxides of the electrode 20 is significantly reduced, thereby not increasing the ohm loss; and on the other hand, the release of metal ions is significantly reduced, thereby extending the lifespan of the proton exchange membrane, and further promoting the durability of the fuel cell.

FIG. 2B is a top schematic view of a protective structure 200 of a polar plate 20 for a fuel cell 10 according to some embodiments of the present disclosure. The protective structure 200 comprises a first material layer 201 and a second material layer 202. Due to the manufacturing process cost and the material cost of the electrolytic water catalytic material, in some embodiments, the area of the second material layer 202 is less than the area of the first material layer 201, e.g., the area of the second material layer 202 may be 50%, 10%, or other ratios of the area of the first material layer 201, as long as the technical effects of the present disclosure can be achieved. As a preferred technical solution to achieve the present disclosure, in some embodiments, the area of the second material layer 202 is 2-3% of the area of the first material layer 201. From the perspective of the manufacturing process, in some embodiments, the second material layer 202 may be a whole area, and the second material layer 202 may also comprise a plurality of sub-part sections 2021 that are spaced apart from each other, such that the plurality of sub-part sections 2021 that are spaced apart from each other form a sub-part section array.

The array shape may be approximately square as shown in FIG. 2B, or may be in other shapes such as a circle, a * shape, a straight-line shape, a cross shape, etc., all belonging to different implementations of the technical solution of the present disclosure, and the present disclosure is not limited thereto.

In some embodiments, attributes of the sub-part sections, such as different sizes, different shapes, etc., are related not only to the technical effects of the anti-inversion, but also to the ease with which the process manufacturing can be achieved. FIG. 2C to FIG. 2E are cross-sectional schematic views of a protective structure 200 of the polar plate 20 for the fuel cell after sectioning the protective structure 200 in FIG. 2B along the arrow direction according to some embodiments of the present disclosure. As shown in FIG. 2C, in some embodiments, cross-sectional views of the plurality of sub-part sections 2021, 2022, 2023 are square, and FIG. 2D illustrates that the cross-sectional views of the plurality of sub-part sections 2021, 2022, 2023 are semi-circular. In some embodiments, shapes of a plurality of sub-part sections 2021, 2022, 2023 may be flexibly designed according to process requirements, such as including a cuboid, a cube, a spheroid, a pyramid, an irregular shape, and the like, as shown in FIG. 2E, the solution that the cross-sectional views of the plurality of sub-part sections 2021, 2022, 2023 comprise a semi-circle and a trapezoid is shown.

According to the technical solution of the present disclosure, in some embodiments, a particle size of the sub-part sections of different shapes may be designed to correlate with an area percentage value of the first material layer 201 of the second material layer 202. The correlation mode can be linear or non-linear correlation. In some embodiments, the higher the area percentage value of the second material layer 202 to the first material layer 201, the smaller the particle size of the sub-part sections of different shapes; in contrast, the lower the area percentage value of the second material layer 202 to the first material layer 201, the greater the particle size of the sub-part sections of different shapes. In some embodiments, the mean particle size of the sub-part sections of different shapes is not greater than 10 μm. In some embodiments, the mean particle size of the sub-part sections of different shapes is 100 nm-10 μm to achieve a balance between the optimal design processing cost and the anti-inversion effect.

In some embodiments, the first material layer 201 and the second material layer 202 are coating layers molded by a physical vapor deposition or thermal spray process. In some embodiments, the first material layer 201 and the second material layer 202 can use vacuum evaporation, sputtering coating, ion coating, arc plasma coating, molecular beam epitaxy and other processes to form a coating layer with a strong binding force to the substrate 300 on the upper surface of the substrate 300. The thermal spraying process can also be used for coating on the upper surface of the substrate 300, so that the metal polar plate 20 can obtain corrosion resistance, oxidation resistance, heat resistance and wear resistance and other properties. The first material layer 201 and the second material layer 202 may be implemented by the same process or may be implemented by different processes. In some embodiments, the second material layer 202 is coated using the same process as the first material layer 201, so that the processing process of the polar plate 20 for the fuel cell according to the present disclosure is compatible with existing processes, and the processing equipment of the first material layer 201 in the conventional techniques can be used for production and processing without increasing the production cost.

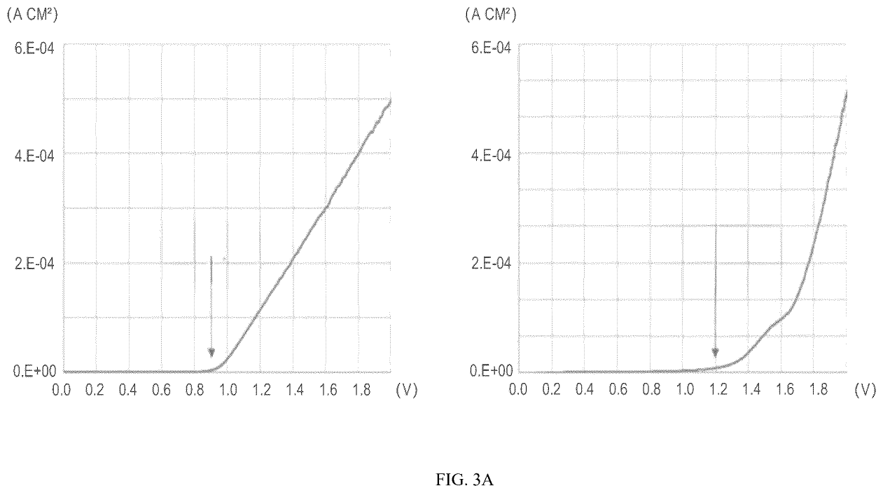

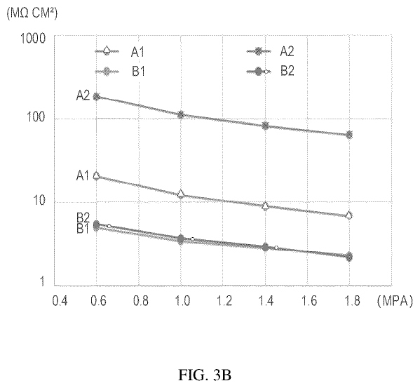

FIG. 3A and FIG. 3B are comparison schematic views of experimental data of a polar plate 20 for a fuel cell according to some embodiments of the present disclosure. FIG. 3A is a comparison schematic view of polarization curve experimental data of the metal polar plate 20, with the transverse axis being the potential applied to the polar plate 20, and the longitudinal axis being marked as the corrosion current density. The left curve is a comparison example 1, which is a solution in the prior art that the metal polar plate has only conventional protective coatings and does not have the second material layer 202, and the right curve is a technical solution of a fuel cell having a second material layer 202 according to some embodiments of the present disclosure. It can be seen that when an inversion occurs in the working process of the fuel cell, the corrosion current density suddenly increases and the corrosion to the metal polar plate 20 suddenly accelerates: In the left comparison example 1, the fuel cell voltage is able to remain in a normal working condition when it is below 1.0 V, while the corrosion to the metal polar plate 20 by the inverted voltage is abnormally accelerated when it is near the 1.2 V voltage, and the corrosion current density is abnormally elevated accordingly. In the solution of the present embodiment at the right, the fuel cell voltage is able to remain in a normal working condition when it is below 1.5 V; the current density is still within the normal threshold range near the 1.5 V voltage; until the voltage value reaches 1.6 V, the current density increases dramatically, where the current density corresponds to the process of producing oxygen gas by water oxidation and decomposition. The solution of the present disclosure achieves the effect of avoiding oxidation corrosion to the metal polar plate 20 by water oxidation in place of oxidation of the substrate 300 and the first material layer 201.

FIG. 3B is a comparison schematic view of ICR experimental data of the polar plate 20 for the fuel cell after applying a normal voltage condition and after applying a 1.6 V voltage for 1 hour according to some embodiments of the present disclosure, illustrating the trend of the corresponding values of the ICR of the polar plate 20 as a function of pressure changes over the surface of the polar plate. Regarding the comparison example 2: Curves A1 and A2 are the comparison example 2, and are solutions in the prior art that the metal polar plate 20 only has a conventional protective coating and does not have a second material layer 202. Under the normal voltage conditions of the fuel cell, the corresponding value of ICR of the metal polar plate 20 is curve A1; when the 1.6 V inverted voltage lasts for up to 1 hour, the corresponding value of ICR of the metal polar plate 20 is curve A2, and it can be seen that the corresponding value of ICR corresponding to A2 is significantly higher than the corresponding value of ICR corresponding to A1. Regarding the embodiments of the present disclosure: Curves B1 and B2 are the technical solution of the polar plate 20 having a second material layer 202 according to some embodiments of the present disclosure. Under the normal voltage conditions of the fuel cell, the corresponding value of ICR of the metal polar plate is curve B1; after the 1.6 V inverted voltage lasts up to 1 hour, the corresponding value of ICR of the metal polar plate is curve B2, it can be seen that the corresponding value of ICR corresponding to B2 is substantially close to the corresponding value of ICR corresponding to B1, that is, after the 1.6 V inverted voltage lasts up to 1 hour, the corresponding value of ICR of the metal polar plate 20 is not significantly changed compared to the corresponding value of ICR under normal voltage conditions of the fuel cell. It can be seen that the technical solution with an anti-inversion structure provided by the embodiments of the present disclosure significantly improves the corrosion resistance of the metal polar plate 20, thereby improving the working stability and working durability of the fuel cell.

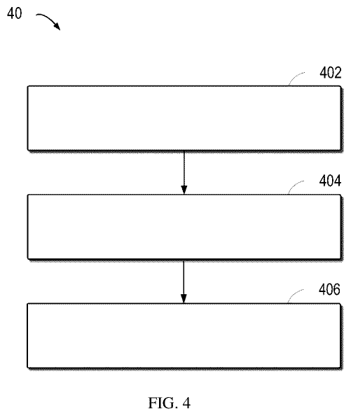

FIG. 4 is a flow chart of a preparation method 40 of a polar plate 20 for a fuel cell according to some embodiments of the present disclosure. At block 402, the method 40 provides a substrate 300, and the substrate 300 is used for allocating a target reactant of a fuel cell and has an electrical conductivity. In block 404, the method 40 provides a first material layer 201, and the first material layer 201 is arranged on an upper surface 311 of the substrate 300 and has a first surface 211 used for being in contact with the upper surface 311 of the substrate 300. In block 406, the method 40 provides a second material layer 202, the second material layer 202 comprises a catalytic material layer for resisting an inverted voltage of the fuel cell, the catalytic material layer comprises a catalytic material, and is arranged on a second surface 212 of the first material layer 201 opposite to the first surface 211, the second material layer 202 has a contact surface 222 used for being in contact with a gas diffusion layer of the fuel cell, i.e., the second material layer 202 is positioned between the first material layer 201 and the gas diffusion layer. In some embodiments, the first material layer 201 comprises a corrosion resistant material layer having an electrical conductivity, the corrosion resistant material layer comprises a corrosion resistant material, and the second material layer 202 comprises a catalytic material layer having an electrical conductivity to resist the inverted voltage of the fuel cell, thereby protecting the first material layer 201 and the substrate 300.

The polar plate 20 for the fuel cell in the embodiments of the present disclosure may be utilized in a fuel cell system, the polar plate 20 may be arranged solely on an anodic side of the fuel cell system 10 or solely on a cathodic side of the fuel cell system 10, and may also be arranged simultaneously on the anodic side and the cathodic side of the fuel cell system 10. The fuel cell system may also be other types of fuel cell systems, which are not limited by the present disclosure. The fuel cell system 10 in the embodiments of the present disclosure may be used not only on new energy cell vehicles to provide an energy source for new energy cell vehicles, but also in other scenarios where energy is required, such as petrochemicals, etc., which are not limited by the present disclosure.

In the technical solution of the present disclosure, the catalytic material in the second material layer 202 improves the corrosion resistance performance of the metal polar plate 20 at a high potential, such that the metal polar plate 20 exhibits better corrosion resistance when the high potential occurs. The present disclosure adopts a polar plate 20 for a fuel cell that comprises a second material layer 202, on one hand, the formation of metal oxides on the metal polar plate is inhibited, such that ICR of the polar plate remains stable, thereby not increasing the ohm loss of the fuel cell; and on the other hand, release of metal ions from the metal polar plate is inhibited, thereby inhibiting corrosion of the proton exchange membrane by the metal ions, and further remitting decomposition of the proton exchange membrane. As such, the second material layer 202 improves the performance of the fuel cell in a plurality of aspects, significantly extending the lifespan of the fuel cell. The polar plate 20 for a fuel cell of the present disclosure is compatible with existing manufacturing processes of the metal polar plate and does not significantly increase the manufacturing cost of the metal polar plate. In terms of the obvious technical effects brought by the present disclosure, the solution of the present disclosure can significantly improve the economic benefits.

Although the present subject matter has been described in languages that are specific to structural features and/or method logical actions, it should be understood that the subject matter defined in the appended claims is not necessarily limited to the particular features or actions described above. Rather, the particular features and actions described above are merely example forms of implementing the claims.

What is claimed is:

1. A polar plate for a fuel cell, comprising:
a substrate configured for allocating a target reactant of the fuel cell and having an electrical conductivity;
a first material layer arranged on an upper surface of the substrate and having a first surface configured to contact the upper surface; and
a second material layer comprising a catalytic material layer used for resisting an inverted voltage of the fuel cell, the catalytic material layer comprising a catalytic material and being arranged on a second surface of the first material layer opposite to the first surface, the second material layer having a contact surface configured to contact a gas diffusion layer of the fuel cell.

2. The polar plate according to claim 1, wherein:
the first material layer comprises a corrosion resistant material layer having an electrical conductivity, the corrosion resistant material layer comprising a corrosion resistant material, and
the second material layer comprises a catalytic material layer having an electrical conductivity.

3. The polar plate according to claim 2, wherein:
a catalytic material in the second material layer comprises an electrolytic water catalytic material.

4. The polar plate according to claim 3, wherein:
the electrolytic water catalytic material is selected from at least one of: ruthenium (Ru), platinum (Pt), iridium (Ir), cobalt (Co), nickel (Ni), rhenium (Re), antimony (Sb), tantalum (Ta), tin (Sn), and oxides thereof.

5. The polar plate according to claim 2, wherein:
an area of the second material layer is less than an area of the first material layer.

6. The polar plate according to claim 5, wherein:
the area of the second material layer is 2-3% of the area of the first material layer.

7. The polar plate according to claim 1, wherein:
the second material layer comprises a plurality of sub-part sections that are spaced apart from each other.

8. The polar plate according to claim 7, wherein:
a mean particle size of the plurality of sub-part sections is not greater than 10 μm.

9. The polar plate according to claim 7, wherein:
a shape of the plurality of sub-part sections comprises at least one of: a square, a cube, a spheroid, a pyramid, and an irregular shape.

10. The polar plate according to claim 1, wherein:
a material of the first material layer is selected from at least one of: metal nitride, metal carbide, and carbon, and
a material of the substrate is selected from at least one of: stainless steel, titanium alloy, and aluminum alloy, and the substrate is configured for allocating a target reactant from an outside of the fuel cell to the gas diffusion layer.

11. The polar plate according to claim 1, wherein:
the first material layer and the second material layer are coating layers molded by a physical vapor deposition or thermal spray process.

12. A preparation method of a polar plate for a fuel cell, comprising:
providing a substrate, the substrate being configured for allocating a target reactant of the fuel cell and having an electrical conductivity;
providing a first material layer, the first material layer being arranged on an upper surface of the substrate and having a first surface configured to contact the upper surface; and
providing a second material layer, the second material layer comprising a catalytic material layer used for resisting an inverted voltage of the fuel cell, the catalytic material layer comprising a catalytic material and being arranged on a second surface of the first material layer opposite to the first surface, the second material layer having a contact surface configured to be in contact with a gas diffusion layer of the fuel cell.

13. The preparation method of the polar plate according to claim 12, wherein:
the first material layer comprises a corrosion resistant material layer having an electrical conductivity, the corrosion resistant material layer comprising a corrosion resistant material, and
the second material layer comprises a catalytic material layer having an electrical conductivity.

14. A fuel cell system, comprising the polar plate for the fuel cell according to claim 1, wherein:
the polar plate is arranged on at least one side of an anodic side and a cathodic side of the fuel cell system.

15. A vehicle, comprising the fuel cell system according to claim 14.
